(19) United States
(12) Patent Application Publication
(10) Pub. No.: US 2018/0053363 A1
(43) Pub. Date: Feb. 22, 2018

(54) SECURED INTEGRATED BUILDING ACCESS

(71) Applicant: STEPHEN MICHAEL RAVIDA, NAPLES, FL (US)

(72) Inventor: STEPHEN MICHAEL RAVIDA, NAPLES, FL (US)

(21) Appl. No.: 15/698,830

(22) Filed: Sep. 8, 2017

Related U.S. Application Data
(60) Provisional application No. 62/377,903, filed on Aug. 22, 2016.

(51) Int. Cl. G07C 9/00; H04N 7/18

(52) U.S. Cl. CPC G07C 9/00158; H04N 7/186; G07C 9/00111

(57) ABSTRACT

An integrated secured building access system is presented that allows an authorized person to remotely grant or deny a visitor building access. The system provides audiovisual communication between a visitor and the access controller via a cloud service operating with the internet or a cellular network and remote devices such as smart phones, personal computers, and/or tablets. The access controller can remotely grant or deny the visitor entry to the building.

### RELATED APPLICATIONS

This application claims the benefit of provisional application 62/377903, filed on Aug. 22, 2016.

### BACKGROUND OF THE INVENTION

### Field of the Invention

The present invention relates to security systems and building access systems.

### Description of the Related Art

Securing both commercial and residential buildings is high priority for the owners and tenants of these types of properties. The ability to do so remotely is even more desirable given that many people are either not present or indisposed when a visitor arrives. The ability to grant or deny access at the point of entry is desirable but not always possible and the inability to do so can create a number of problems and/or general nuisance for the owner or tenant.

There currently exist a range of approaches to help secure properties. However, a problem with the known methods is that they require someone present on the property to grant or deny access. Further, the known methods are constrained to outdated communication methods. Additionally, known methods for securing a property and known methods for granting or denying access are not combined into a single system. Therefore, there exists a need for a single system both to secure and to permit or deny access that is not restricted by outdated technology and allows a remote user to control the system.

### SUMMARY OF THE INVENTION

These and other objects are achieved by the instant invention. The present invention is an integrated building access system that has a communication device component at the building entry point in communication with the tenant or owner's PC/tablet/mobile device by means of the internet or cellular network.

It is an object of the invention for a system to provide the tenant or owner (access controller) with an audiovisual access request and callback number of the visitor at the building entry point.

It is an object of the invention for a system to communicate the access request to the access controller instantaneously by means of a cloud service.

It is an object of the invention for a system including the cloud service that the service receives the access request and processes and sends the request to the access controller by SMS/text message, SMTP/e-mail message, push notification, or other communicable means via the internet or cellular network.

It is an object of the invention that the access controller be prompted to permit or deny building access.

It is an object of the invention that the access request expires in a predetermined amount of time, between 60-300 seconds.

It is an object of the invention that the access controller has the option to contact the visitor with a callback number.

It is an object of the invention that if the access controller chooses to permit access, an approval message is transmitted back to the building entry point via the cloud service.

It is an object of the invention that granting approved access will transmit an “access granted” message to the visitor.

It is an object of the invention that granting approved access will activate a door actuator module to provide the visitor with immediate physical access to the building.

It is an object of the invention that if the access controller chooses to deny access, an “access denied” message is transmitted back to the building entry point via the cloud service.

It is an object of the invention that an access request may be tried again immediately.

It is an object of the invention that to prevent nuisance attempts a property administrator may set a timeout setting limiting the number of consecutive access requests upon multiple access denials.

It is an object of the invention that the transmission of the access request reach the access controller immediately.

Other advantages and novel features of the present invention are more apparent in the following detailed description of the invention when considered in conjunction with the accompanying drawings.

### BRIEF DESCRIPTION OF THE DRAWINGS

FIG. 1 is a high-level function diagram of the integrated secure building access system; and

FIG. 2 is a close-up diagram of the building entry point device.

### DESCRIPTION OF THE PREFERRED EMBODIMENTS

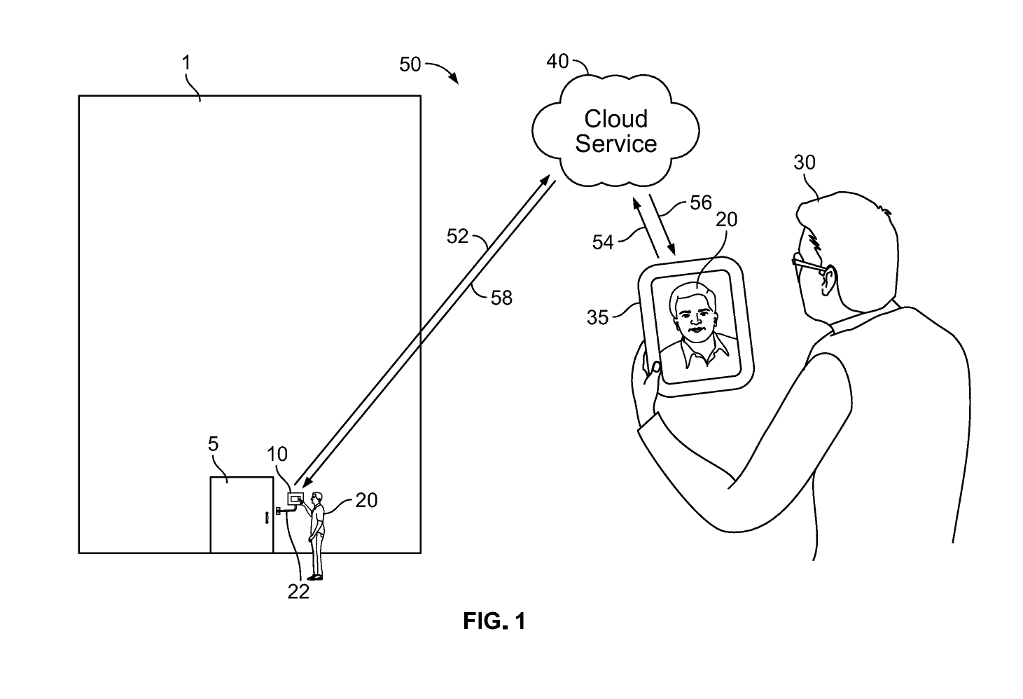

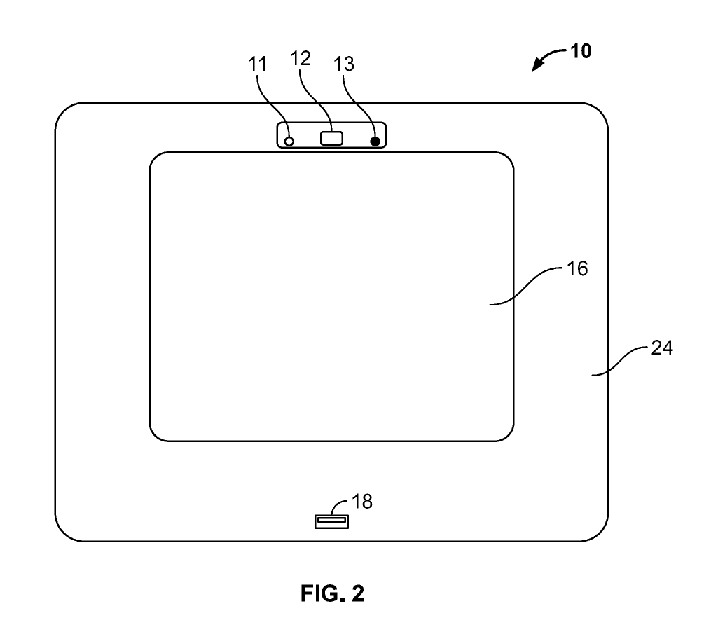

The best mode for carrying out the invention is presented in terms of its preferred embodiment, herein depicted within FIGS. 1 and 2.

### Detailed Description of the Figures

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

Referring now to the figures, the integrated secured building access system 50 comprises a building entry point device 10 to interface with a building visitor 20 that incorporates a user interface 16 (such as a display, touchscreen, keypad or other comparable interface, optionally having memory for storage of video, for example) a camera 12, a microphone, an RFID reader 22, a wired or wireless connection to the internet or cellular network, and a door actuator module 26 which communicates with a door securing mechanism when directed by a system generated signal; an associated cloud service 40; an associated remote device 35 (such as a tablet, smartphone, personal computer, or similar device); and a door securing mechanism connected to the door actuator module. In the depicted embodiment of the building entry point device 10 shown in FIG. 2, there is also a “camera active” notification light 11 to alert the visitor 20 when the camera 12 is recording and an auto focus IR lens 13 to ensure optimal video recording. This embodiment of the building entry point device 10 is also shown in a protective case 24, which is preferable to protect the building entry point device 10 from damage and the elements. The RFID reader 22 is in connection with the building entry point device 10 through a USB or similar type of connection or can be in communication with the building entry point device 10 through any means known to one skilled in the art.

The integrated secured building access system 50 is activated by a visitor 20 at the entry point 5 of the building 1. The visitor 20 selects a type of access, either direct access or remote access from a building entry point device 10. For the direct access option, the visitor 20 preferably should have a PIN or RFID badge and by the use of the RFID badge with the RFID reader 22 or by the use of the PIN with the user interface 16 may gain immediate access to the building 1. For the remote access option, the visitor 20 may select an access controller 30 (i.e. one of many tenants) from a directory on the building entry point device 10. The directory may be stored in memory on the building entry point device 10 or may be remotely stored on the cloud service 40. In this embodiment of the building entry point device 10, nothing is written to local storage on the device, meaning that the directory is remotely stored on the cloud service 40. When the building entry point device 10 starts up, the building entry point device 10 connects to the cloud service 40 and provides its hardware serial number. Upon validation of the serial number and an active service account, the configuration for the building entry point device 10 service is downloaded from the cloud service 40. The configuration will remain in active RAM, and is therefore never written to local storage, as long as the building entry point device 10 is operating. Further, if the building entry point device 10 is lost or stolen, the account can be deactivated resulting in no data loss or compromise to the directory or sensitive information.

After selecting an access controller 30 from the directory, an audiovisual message is generated of the visitor 20 at the entry point 5 of the building 1 utilizing the camera 12 and the microphone of the building entry point device 10. Preferably, the audiovisual message along with a callback number supplied by the visitor 20 using the building entry point device 10 comprises the access request. A transmission 52 of access request is uploaded by the building entry point device 10 to a cloud service 40 via a wired or wireless internet or cellular network. A transmission 54 of the access request is sent by the cloud service 40 to the access controller 30. While transmission of the access request is occurring, a message is displayed to the visitor 20 via the user interface 16 on the building entry point device 10 to the effect that “the message is being sent” or “your message is being sent”. The transmission 52 of the access request is processed by the cloud service 40 and relayed to the access controller 30 by a transmission 54 of at least one of the following methods: SMS/Text message, SMTP/E-mail message, push notification, or other communicable means via the internet or cellular network. Upon receiving the access request, the access controller 30 is prompted by the remote device 35 to permit or deny the visitor 20 access to the building 1.

If access is denied by the access controller 30, an “access denied” message will be generated by the access controller 30 using the remote device 35. A transmission 56 of the “access denied” message is sent to the cloud service 40, then the message is relayed to the visitor 20 by a transmission 58 from the cloud service 40 to the building entry point device 10. The visitor 20 receives the message on the user interface 16 notifying them that access has been denied by displaying a message on the building entry point device 10, to wit, “access denied.”

If access is granted by the access controller 30, an “access granted” message will be generated by the access controller 30 using the remote device 35. A transmission 56 of the “access granted” message is sent to the cloud service 40, then the message is relayed to the visitor 20 by a transmission 58 from the cloud service 40 to the building entry point device 10. The visitor 20 receives the message on the user interface 16 notifying them that access has been granted by displaying a message on the building entry point device 10, to wit, “access granted.” Simultaneously, the door actuator module 26 will be activated. Normally, the door 5 is locked by a door securing mechanism when the door actuator module 26 is not activated. The door actuator module 26 receives a signal from the building entry point device 10, through a wired or wireless connection, to actuate the door latching (and unlatching) mechanisms, converts the signal to preferably a 5-volt analog signal which, by the use of the relay, is converted to the voltage matching the voltage required by any one of a number of available door latching (and unlatching) mechanisms. The door actuator module 26 comprises a digital to analog converter, a wire connection with the building entry point device 10 and a relay. When activated, the door actuator module 26 sends an appropriate voltage signal to the door latching mechanism which unlocks the locked door 5, thereby allowing the visitor 20 to enter the building 1.

The access controller 30 also has the option to call the visitor 20 using the callback number provided in the access request. If the access controller 30 does not permit or deny access, the access request will expire after a predetermined or preselected amount of time. Preferably, the access request will expire at a preselected time ranging from between about 60 and about 300 seconds.

The foregoing descriptions of specific embodiments of the present invention are presented for purposes of illustration and description. They are not intended to be exhaustive nor to limit the invention to precise forms disclosed and, obviously, many modifications and variations are possible in light of the above teaching. The embodiments were chosen and described in order to best explain principles of the invention and its practical application, to thereby enable others skilled in art to best utilize the invention and its various embodiments with various modifications as are suited to the particular use contemplated. It is intended that the scope of the invention be defined by the Claims appended hereto and their equivalents. Therefore, the scope of the invention is to be limited only by the following claims.

What is claimed is:

1. An integrated secured building access system comprising:
a building entry point device comprising in combination:
a user interface for data input and for input of access request information from a visitor and for relaying a response from an access controller,
a camera for video recording and access request information,
a microphone for audio receiving and access request information,
a communication means for connecting to a cloud service through an internet or a cellular network, and
a signal generating means for transmitting a signal to a door actuator module;
a door actuator module for receiving a signal from the building entry point device and transmitting a signal to a door securing mechanism in response to a signal originating from the access controller;
a remote device for the receipt and transmittal of data from the access controller to the building entry point device;
a cloud service for the receipt and transmittal of signals to and from the building entry point device and to and from the remote device; and
a door securing mechanism operative in response to the signal from the door actuator module for unlocking an access door.

2. The integrated secured building access system of claim 1 wherein the building entry point device further comprises memory for storing an audiovisual recording.

3. The integrated secured building access system of claim 2 further comprising an RFID reader for alternate building access.

4. The integrated secured building access system of claim 3 wherein the access request comprises an audiovisual message and a phone number.

5. An integrated building access system of claim 4 wherein the remote device is a smartphone, tablet or personal computer.

6. An integrated secured building access system comprising:
a building entry point device comprising in combination:
a user interface for data input and input of access request information from a visitor and for relaying a response from an access controller,
a camera for video recording and access request information,
a microphone for audio receiving and access request information,
a communication means for connecting to a cloud service through an internet or a cellular network, and
a signal generating means for transmitting a signal to a door actuator module;
a door actuator module for transmitting a signal to a door securing mechanism in response to a signal;
a remote device for the receipt and transmittal of data from the access controller to the building entry point device;
a cloud service for the receipt and transmittal of signals to and from the building entry point device and to and from the remote device;
a door securing mechanism operative in response to the signal from the door actuator module for unlocking an access door;
wherein the building entry point device further comprises memory for storing an audiovisual recording;
an RFID reader for alternate building access;
wherein the access request comprises an audiovisual message and a phone number; and
wherein the remote device is a smartphone, tablet or personal computer.
